(19) United States
(12) Patent Application Publication
(10) Pub. No.: US 2011/0315257 A1
(43) Pub. Date: Dec. 29, 2011

(54) LINEAR HOLLOW SPOOL VALVE

(75) Inventors: Todd Alan Anderson, Niskayuna, NY (US); Manoj Ramprasad Shah, Latham, NY (US); Philip Paul Beauchamp, Rexford, NY (US); Rammohan Rao Kalluri, Ongole (IN); Suma Memana Narayana Bhat, Bangalore (IN); Hareesh Kumar Reddy Kommepalli, Schenectady, NY (US)

(73) Assignee: GENERAL ELECTRIC COMPANY, SCHENECTADY, NY (US)

(21) Appl. No.: 12/821,167

(22) Filed: Jun. 23, 2010

(51) Int. Cl. F16K 11/07

(52) U.S. Cl. 137/625.69

(57) ABSTRACT

A valve system for pressure exchanger tubes of an energy recovery system is provided. The valve system includes a valve housing, a flow distributor, a hollow spool and a sealing system. The valve housing may comprise a set of high-pressure ports and a set of low-pressure ports. The flow distributor allows the flow to and from the set of high-pressure ports and the set of low-pressure ports within the valve housing. The hollow spool may be configured to reciprocate axially in a radial clearance between the valve housing and the flow distributor. The hollow spool may connect the pressure exchanger tube in fluid communication with the high-pressure ports or the low-pressure ports. The sealing system may be provided within the valve housing for imparting substantial hydraulic balance to the hollow spool.

### BACKGROUND

Embodiments of the present invention relate to an energy recovery system. More particularly, the embodiments of the present invention relate to a valve system for the energy recovery system.

An energy recovery system is a device that utilizes a fluid stream at a higher pressure to pressurize another fluid at a lower pressure. Energy recovery systems are generally used in desalination plants to pressurize a feed stream by using high pressure concentrate.

An energy recovery system may include a pressure exchanger tube and a piston reciprocating inside the pressure exchanger tube. Further, a valve system may control the flow of feed water into the pressure exchanger tube and the concentrate out of the pressure exchanger tube. One form of the energy recovery system may include two or more pressure exchanger tubes. Various valve systems are known in the art, for example, rotary valve systems and linear valve systems.

Valve systems are generally connected to the two pressure exchanger tubes and synchronized with the movement of the two pistons. Such valve systems are usually complicated, heavy, expensive, and more susceptible to failure. Moreover, independent operation of the pressure exchanger tubes may not be possible.

During operation, the valve systems are subjected to various hydraulic loads, for example, radial loads and axial loads. Some of these hydraulic loads may be unbalanced and may oppose an applied actuating load. Consequently, higher actuation energy may be necessary to operate the valve system. This may increase the cost of actuating the valve system and may also reduce the efficiency of the energy recovery system. Also, unbalanced loads may reduce the overall life of the sealing system.

Further, known pressure exchanger tubes and valve systems may be actuated by various means: electromagnetic, hydraulic, pneumatic, and the like. In the case of hydraulic or pneumatic means, one or more shafts may have to penetrate into the pressure exchanger tubes and the valve systems through separate sealing system. This may increase the cost and complexity of the energy recovery system. The sealing system themselves may be vulnerable to leakage.

Therefore, there is a need for a valve system for pressure exchange tubes of an energy recovery system, which overcomes these, and other related problems.

### BRIEF DESCRIPTION

The present invention provides a valve system for pressure exchanger tubes of an energy recovery system that overcomes the aforementioned drawbacks. The valve system enables appropriate actuation of the high-pressure ports and the low-pressure ports to allow pressure exchange.

According to an aspect of the present invention, the valve system includes a valve housing, a flow distributor, a hollow spool and a sealing system. The valve housing may comprise a set of high-pressure ports and a set of low-pressure ports. The flow distributor allows the flow to and from the set of high-pressure ports and low-pressure ports within the valve housing. The hollow spool may be configured to reciprocate axially in a radial clearance between the valve housing and the flow distributor. The hollow spool may connect the pressure exchanger tube in fluid communication with the high-pressure ports or the low-pressure ports. The sealing system may be configured to provide substantial hydraulic balance to the hollow spool. Due to the axial hydraulic balance, lower actuation force may be required for controlling the movement of the hollow spool. Accordingly, the low actuation force may permit the use of an externally driven hollow spool which overcomes previous challenges with the actuators that penetrate the pressure exchanger tubes or the valve body.

These and other advantages and features will be more readily understood from the following detailed description of the embodiments of the invention that is provided in connection with the accompanying drawings.

### BRIEF DESCRIPTION OF THE FIGURES

FIG. 1 illustrates a schematic of an energy recovery system, according to an embodiment of the present invention.

FIG. 2 illustrates a perspective sectional view of a valve system, according to an embodiment of the present invention.

FIG. 3 illustrates a sectional view of the valve system with a hollow spool in a first axial position, according to an embodiment of the present invention.

FIG. 4 illustrates a sectional view of the valve system with the hollow spool in a third axial position, according to an embodiment of the present invention.

FIG. 5 illustrates a sectional view of the valve system with the hollow spool in a second axial position, according to an embodiment of the present invention.

### DETAILED DESCRIPTION

Various embodiments of the present invention will be described in detail below with reference to the accompanying drawings. It will be apparent, however, that these embodiments may be practiced without some or all of these specific details. In other instances, well known process steps or elements have not been described in detail in order to not to unnecessarily obscure the description of the invention. The following example embodiments and their aspects are described and illustrated in conjunction with apparatuses, methods, and systems which are meant to be illustrative examples, not limiting in scope.

The invention provides a valve system for pressure exchanger tubes of an energy recovery system. The energy recovery system is a device that utilizes a waste stream of a sub-system to minimize the input of energy to the whole system by exchange of energy from one sub-system to another. In desalination systems, the energy recovery system may be utilized to transfer the pressure between the incoming and outgoing flow of a reverse osmosis system. More specifically, pressure may be extracted from the high pressure concentrate solution and transferred to the low pressure feed water resulting in improved desalination system energy efficiency. Thus, cost of production of portable water may be reduced by employing the energy recovery system.

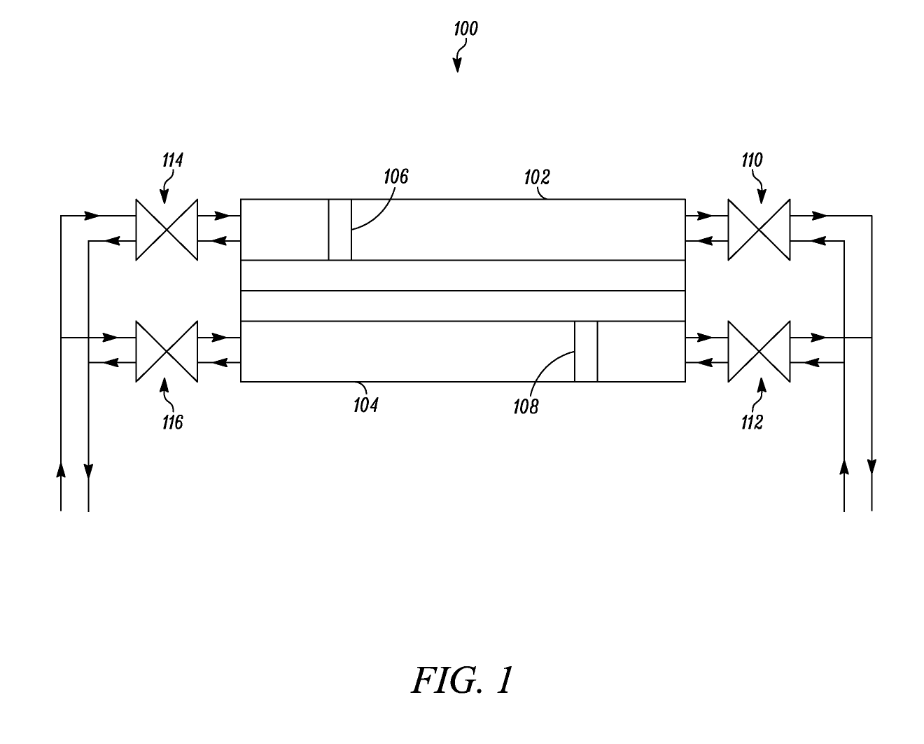

FIG. 1 is a schematic illustration of an energy recovery system 100 in accordance with various embodiments of the present invention. The energy recovery system 100 may include two pressure exchanger tubes 102 and 104 as illustrated in FIG. 1. A pressure exchanger tube is generally used for exchanging hydraulic pressure from a fluid stream at relatively high pressure to a fluid stream at relatively low pressure. Further, pistons 106 and 108 may be disposed respectively within the pressure exchanger tubes 102 and 104 in slidable and sealing arrangement with the walls of the tubes. The pistons 106 and 108 may be adapted to move longitudinally within each of the pressure exchanger tubes 102 and 104. The pistons 106 and 108 may be actuated by various actuating means, for example, electromagnetic means, pneumatic means, and hydraulic means. Those skilled in the art will appreciate that other means of actuation could be limited and the aforementioned examples are a non-limiting set. Pneumatic means may involve the use of a shaft with a seal for actuating the pistons 106 and 108. The energy recovery system 100 may further include four valves 110, 112, 114 and 116 (two for each of the pressure exchanger tubes 102 and 104) for controlling the fluid flow into and out of the pressure exchanger tubes 102 and 104. Further, a housing (not shown) of each of the valves may include two high-pressure ports and two low-pressure ports. The energy recovery system 100 may have one or more pressure exchanger tubes arranged in various possible configurations.

In an exemplary embodiment of the present invention, the energy recovery system 100 may be employed in a desalination plant. In a desalination system, the energy recovery system 100 may be utilized to achieve pressure exchange between discharge concentrate solution (at relatively high pressure) and feed water (at relatively low pressure). Referring to FIG. 1, on one side of the pressure exchanger tubes 102 and 104, one line may be connected to the concentrate solution line via valves 110 and 112 and the other line may be connected to a drain. On the other side of the pressure exchanger tubes 102 and 104, one line may be connected to the feed water line and the other line may be connected to the high pressure side of an a reverse osmosis subsystem. Operation of the pressure exchanger tube 102 in one cycle of pressure exchange is explained below with reference to FIG. 1.

Initially, the piston 106 may be at the extreme left position inside the pressure exchanger tube 102 and all the ports of the valves 110 and 114 may be closed. In this position, the pressure exchanger tube 102 is filled with the concentrate solution. The low-pressure ports of the valves 110 and 114 may then be opened. Due to opening of the low-pressure ports of the valve 110, the feed water (at relatively low pressure) may be drawn into the pressure exchanger tube 102. The feed water pushes the piston 106 from the left side and drains out the concentrate solution. The piston 106 thus moves to the extreme right and the pressure exchanger tube 102 is now filled with the feed water. When the piston 106 reaches the extreme right position, the low-pressure ports of the valves 110 and 114 are closed. This completes a first half of the cycle of pressure exchange involving the movement of the piston 106 from the extreme left position to the extreme right position.

In a second half of the cycle of pressure exchange, the high-pressure ports of the valve 110 may be opened. The concentrate solution may push the piston 106 towards left with a high pressure. As the feed water is incompressible, the pressure of the feed water in the pressure exchanger tube 102 may increase to the pressure of the concentrate solution. The high-pressure ports of the valve 114 may then be opened. An extra boost may be provided to the piston 106 by an electromagnetic force. The concentrate solution (at relatively high pressure) along with the extra boost may drive the feed water out of the high-pressure ports of the valve 114 resulting in movement of the piston 106 to the extreme left position. The movement of the piston 106 from the extreme right position to the extreme left position defines the second half of the cycle of pressure exchange. Pressure is thus exchanged from the high pressure concentrate solution to the low pressure feed water. Further, these steps may be repeated to achieve pressure exchange in every cycle. The pressure exchanger tube 104 may be operated in the similar manner as the pressure exchanger tube 102.

For maintaining continuous flow of the feed water out of the energy recovery system 100, the pistons 106 and 108 of the pressure exchanger tubes 102 and 104 respectively may be operationally synchronized to move with a phase difference of about 180 degrees. Specifically, the piston 106 and the piston 108 may be actuated with a phase difference of 180 degrees.

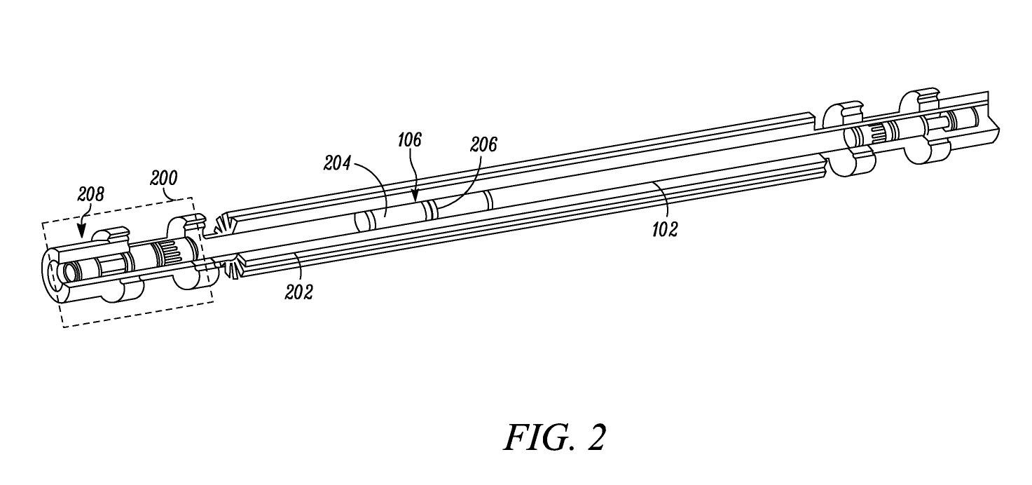

FIG. 2 illustrates a perspective view of a valve system 200 for the energy recovery system 100 in accordance with an embodiment of the present invention. The valve system 200 may be used in a desalination system. Coils 202 may be wound around the pressure exchanger tube 102 of the energy recovery system 100. Further, a controller may be used to control an electric current supplied to the coils 202. In an embodiment of the present invention, an electromagnetic actuating means may be used to control the piston 106. The piston 106, disposed within the pressure exchanger tube 102, may consist of permanent magnets 204 wound around the circumference of the piston 106. Thus, the piston 106 may experience an axial force generated by the interaction of the coils 202 carrying the electric current and the magnetic field of the permanent magnets 204. The electric current supplied to the coils 202 may be controlled for controlling the movement of the piston 106 within the pressure exchanger tube 102. In other embodiments of the present invention, linear motion actuating means, such as, pneumatic means and hydraulic means may be used to control the movement of the piston 106. Further, a seal 206 may be provided to seal the piston 106 with the walls of the pressure exchanger tube 102 to minimize mixing of the low pressure fluid stream and the high pressure fluid stream. The seal 206 may also carry other loads such as weight, friction and miscellaneous loads while the piston 106 is sliding within the pressure exchanger tube 102.

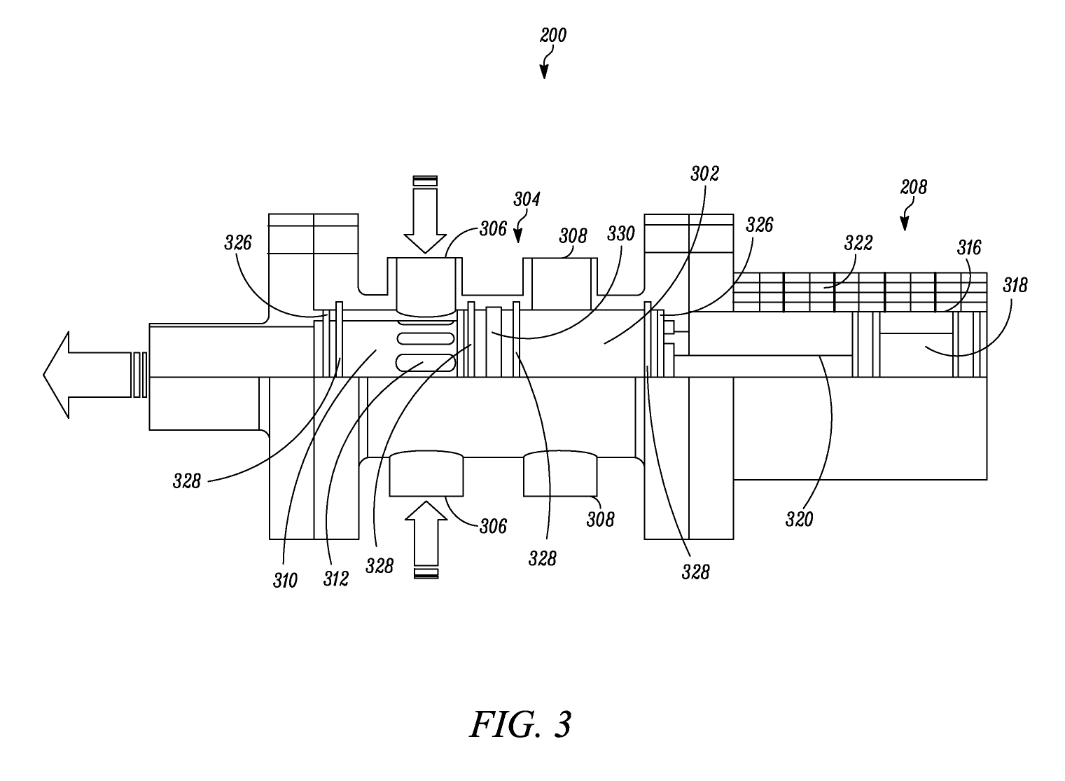

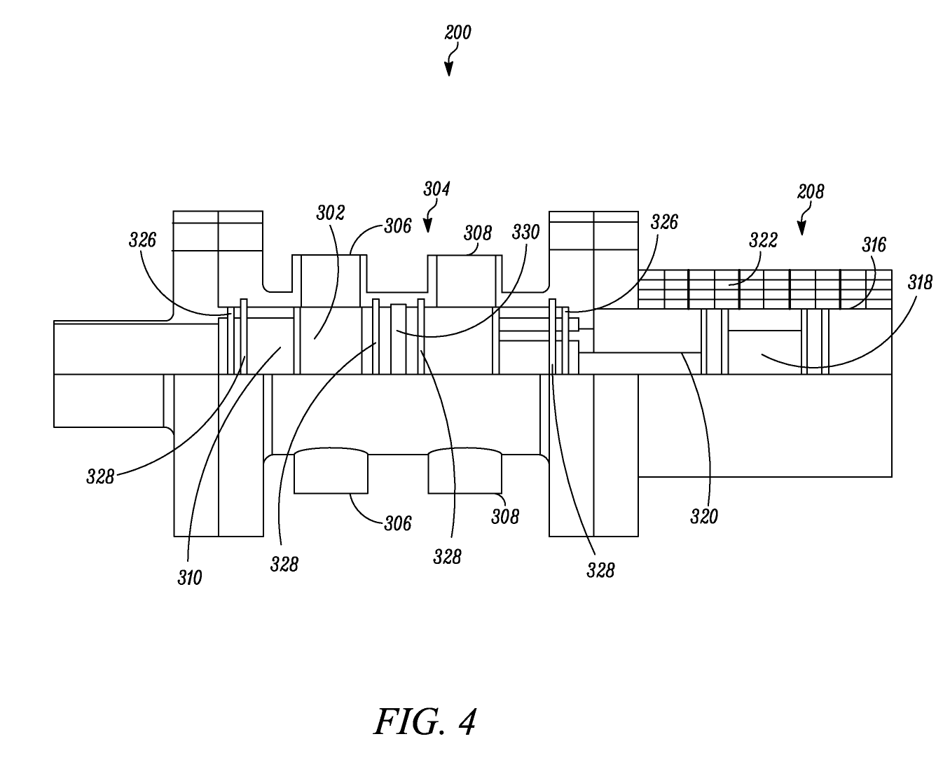

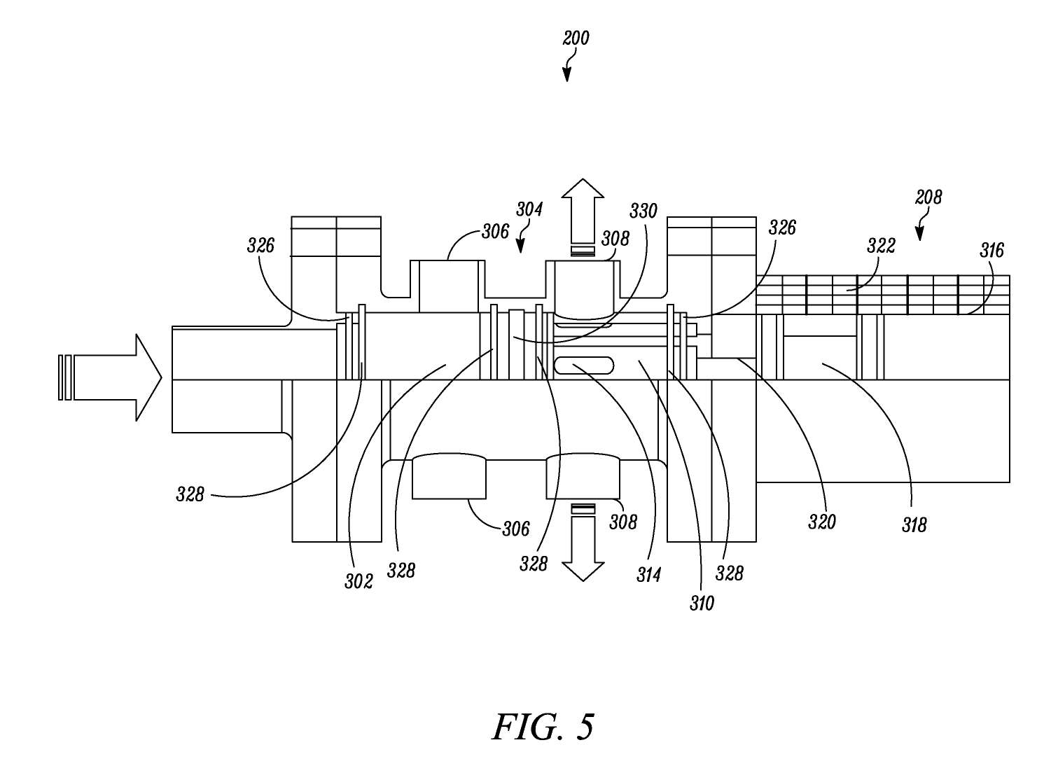

In an embodiment of the present invention, the valve system 200 may include a valve actuator 208 for controlling the opening/closing of the valve. Further, a sensor may be used to sense the position of the piston 106. The valve actuator 208 may control the opening/closing of the valve depending on the sensed position of the piston 106. Specifically, timing of the piston 106 reaching its extreme position (at either end of the pressure exchanger tube 102) and the opening/closing of the valve may be controlled by the valve actuator 208. Referring to FIG. 1, the valve system 200 may be implemented in at least one of the valves 110, 112, 114 and 116 of the energy recovery system 100. The valve system 200 corresponding to the pressure exchanger tube 102 may be controlled independent of a similar valve system for the pressure exchanger tube 104. The construction and working of the valve system 200 in various configurations is explained in detail in conjunction with FIG. 3, FIG. 4 and FIG. 5. Specifically, working of the valve system 200 involving a hollow spool in a first, a second, and a third axial position is explained in conjunction with FIG. 3, FIG. 5, and FIG. 4 respectively.

FIG. 3 illustrates a sectional view of the valve system 200 with a hollow spool 302 in the first axial position, according to an embodiment of the present invention. The valve system 200 includes a valve housing 304. The valve housing 304 may have a tubular shape and is connected to the pressure exchanger tube. Further, the valve housing 304 may include a set of high-pressure ports 306 and a set of low-pressure ports 308. The set of high-pressure ports 306 may include at least two radial high-pressure ports. The circumferential separation between the two radial high-pressure ports may be about 360/(number of high-pressure ports) degrees. Similarly, the set of low-pressure ports 308 may include at least two radial low-pressure ports circumferentially separated by about 360/(number of low-pressure ports) degrees. Referring to FIG. 3, the valve housing 304 may include two high-pressure ports 306 circumferentially separated by about 180 degrees and two low-pressure ports 308 circumferentially separated by about 180 degrees.

Although FIG. 3 illustrates a particular implementation, it will be appreciated that the position of the high-pressure ports and the low-pressure ports may be interchanged. Specifically, the ports 306 may be the low-pressure ports and the ports 308 may be the high-pressure ports.

As shown in FIG. 3, the valve system may include a flow distributor 310. The flow distributor 310 may be tubular and hollow in shape and located inside the valve housing 304. The flow distributor 310 may be configured to distribute the flow to and from the high-pressure ports 306 and the low-pressure ports 308. In an embodiment of the present invention, the flow distributor 310 may include a first set of circumferential openings 312 that are axially aligned with the high-pressure ports 306 and a second set of circumferential openings 314 (shown in FIG. 5) that are axially aligned with the low-pressure ports 308. In an alternate embodiment of the present invention, the flow distributor 310 may include only one set of circumferential openings that extend from the high-pressure ports 306 to the low-pressure ports 308. The circumferential openings 312 and 314 may facilitate the flow to and from the high-pressure ports 306 and the low-pressure ports 308.

Referring to FIG. 3, the valve system further includes the hollow spool 302. In various embodiments of the present invention, the hollow spool 302 may be configured to reciprocate axially in a radial clearance between the valve housing 304 and the flow distributor 310. The hollow spool 302 may selectively connect the pressure exchanger tube in fluid communication with the high-pressure ports 306 or the low-pressure ports 308. In the first axial position, the hollow spool 302 may be axially aligned in a way that it allows fluid communication between the high-pressure ports 306 and the pressure exchanger tube. Specifically, the hollow spool 302 may be axially aligned so as to facilitate fluid communication between the high-pressure ports 306 and the circumferential openings 312 as shown in the FIG. 3. Thus, high pressure fluid stream may flow into the pressure exchanger tube via the high-pressure ports 306. Further, in the first axial position the hollow spool 302 may also preclude fluid communication between the low-pressure ports 308 and the pressure exchanger tube. In other words, the hollow spool 302 may be axially aligned so as to preclude fluid communication between the low-pressure ports 308 and the circumferential openings 314. The hollow spool 302 may have radial openings near the axial ends, which may provide substantial hydraulic balance to the hollow spool 302. The circumferential separation of 180 degrees between the two ports of the high-pressure ports 306 or the low-pressure ports 308 may enable mechanical radial force balance of the hollow spool 302.

The valve actuator 208 may control the movement of the hollow spool 302. In an embodiment of the present invention, the valve actuator 208 includes an actuator housing 316, an actuator piston 318 and an actuator shaft 320. The actuator housing 316 may be tubular in shape and is connected to the valve housing 304. Actuator coils 322 may be wound around the actuator housing 316. Further, the actuator piston 318 may reciprocate within the actuator housing 316. The actuator piston 318 may be hollow in shape. Further, the actuator shaft 320 may connect the actuator piston 318 to the hollow spool 302 for controlling the movement of the hollow spool 302. The hollow spool 302 may have a connecting member at one end for receiving the actuator shaft 320. Further, the flow distributor 310 may have an opening to allow the connecting member of the hollow spool 302 to reciprocate between various positions (between the first axial position and the second axial position) of the hollow spool 302. An actuating means may be used to control the movement of the actuator piston 318. The actuating means may include, for example, electromagnetic means, pneumatic means, hydraulic means, and the like. Those skilled in the art will appreciate that other means of actuation could be limited and the aforementioned examples are a non-limiting set.

The actuating means may use the position of the piston sliding within the pressure exchanger tube to control the opening/closing of the valve system 200. A sensor may be used to obtain the position of the piston. The sensed position may be used to control the opening/closing of the high-pressure ports 306 and the low-pressure ports 308. The sensed position of the piston may be used by the actuating means to control the movement of the actuator piston 318 such that the timing of the piston reaching its extreme position at the either end of the pressure exchanger tube and the opening/closing of the high-pressure ports 306 and the low-pressure ports 308 may be synchronized.

Further, the valve system 200 may include a sealing system provided inside the valve housing 304. In an embodiment of the present invention, the sealing system may include axial seals 326 at both the ends of the flow distributor 310 as shown in the FIG. 3. The axial seals 326 may minimize the contact area and reduce the hydraulic imbalance of the hollow spool 302. Also, the sealing system may include radial seals 328 with or without axial seals 326. The radial seals 328 may minimize the fluid flow between the set of high-pressure ports 306 and the set of low-pressure ports 308 when the hollow spool 302 is at the first axial position or the second axial position. Further, the radial seals 328 may substantially avoid the fluid communication between the high-pressure ports 306 and the low-pressure ports 308. The radial seals 328 may include one or more sealing rings. Further, the radial seals 328 may include a guide ring 330 along with the sealing rings. The sealing system may hydraulically balance the hollow spool 302 in the axial direction.

FIG. 4 illustrates a sectional view of the valve system 200 with the hollow spool 302 in the third axial position, according to an embodiment of the present invention. In the third axial position, the hollow spool 302 blocks the high-pressure ports 306 and the low-pressure ports 308. In the third axial position, the hollow spool may be hydraulically balanced in the axial direction through fluid communication between the end faces through the center of the hollow spool 302. The hollow spool 302 may be moved towards left from the first axial position to reach the third axial position. The hollow spool 302 in the third axial position may preclude the fluid communication between the high-pressure ports 306 and the pressure exchanger tube, and also between the pressure exchanger tube and the low-pressure ports 308. Specifically, the hollow spool 302 may be axially aligned so as to preclude the fluid communication between the high-pressure ports 306 and the circumferential openings 312 and also between the low-pressure ports 308 and the circumferential openings 314. The hollow spool 302 may then be moved towards left from the third axial position to reach the second axial position. The third axial position may be substantially between the first and the second axial position of the hollow spool. The third axial position may be a position from a range of positions between the first axial position and the second axial position such that the hollow spool 302 blocks the high-pressure ports 306 and the low-pressure ports 308.

FIG. 5 illustrates a sectional view of the valve system 200 with the hollow spool 302 in the second axial position, according to an embodiment of the present invention. In the second axial position, the hollow spool 302 may be axially aligned in such a way that it allows fluid communication between the low-pressure ports 308 and the pressure exchanger tube. Specifically, the hollow spool 302 may be axially aligned so as to facilitate fluid communication between the low-pressure ports 308 and the circumferential openings 314 as shown in the FIG. 5. Thus, low pressure fluid stream flows out of the pressure exchanger tube via the low-pressure ports 308. Further, in the second axial position the hollow spool 302 may preclude fluid communication between the high-pressure ports 306 and the pressure exchanger tube. In other words, the hollow spool 302 may be axially aligned so as to preclude fluid communication between the high-pressure ports 306 and the circumferential openings 312. Thus, the hollow spool 302 may reciprocate between the first axial position and the second axial position. In an embodiment of the present invention, a radial clearance between the hollow spool 302 and the tubular valve housing 304 may be minimized in order to substantially reduce fluid flow between the high-pressure ports 306 and the low-pressure ports 308, when the hollow spool 302 is transitioning from the first axial position to the second axial position or vice versa.

In an embodiment of the present invention, the hollow spool 302 may have radial openings near the axial ends, which may provide substantial hydraulic balance to the hollow spool 302 when the hollow spool 302 is in the first axial position or the second axial position. A leakage path may be provided between the high-pressure ports 306 and the low-pressure ports 308. The leakage path may allow mixing of the high pressure fluid stream and the low pressure fluid stream to provide hydraulic balance to the hollow spool 302. Presence of the leakage path may provide hydraulic balance to the hollow spool 302 in substantially all positions of the hollow spool 302. Although fluid communication is allowed to balance the forces on each end of the hollow spool 302, leakage in and out of the high-pressure ports 306 and the low-pressure ports 308 may be minimized through the sealing system. The radial seals 328 may minimize the fluid flow between set of high-pressure ports 306 and set of low-pressure ports 308 when the hollow spool 302 is at the first axial position or the second axial position.

In various embodiments of the present invention, the valve system 200 has been explained in conjunction with the energy recovery system 100, with pistons 106 and 108 configured to boost the pressure of the feed water. However, those of ordinary skilled in the art may appreciate that the valve system 200 may also be utilized in any reverse osmosis systems, for example, reverse osmosis systems having energy recovery systems with passive pressure exchanger tubes and utilizing booster pumps.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A valve system for an energy recovery system having at least one pressure exchanger tube, the valve system comprising:
a tubular valve housing connected to the pressure exchanger tube, the tubular valve housing comprising:
a set of high-pressure ports comprising at least two radial high-pressure ports circumferentially separated by approximately 360/(number of radial ports) degrees; and
a set of low-pressure ports comprising at least two radial low-pressure ports circumferentially separated by approximately 360/(number of radial ports) degrees;
a hollow tubular flow distributor located inside the tubular valve housing and configured to distribute flow to and from the set of high and low-pressure ports within the tubular valve housing;
a hollow spool configured to reciprocate axially in a radial clearance between the tubular valve housing and the hollow tubular flow distributor to selectively connect the at least one pressure exchanger tube in fluid communication with one of the set of high-pressure ports and the set of low-pressure ports, wherein the hollow spool is substantially hydraulically balanced during the operation of the energy recovery system; and
a sealing system provided inside the tubular valve housing that substantially hydraulically balances the hollow spool in the axial direction in all the positions of the hollow spool.

2. The valve system of claim 1, wherein the hollow spool is configured to reciprocate axially between a first axial position and a second axial position.

3. The valve system of claim 2, wherein in the first axial position the hollow spool is axially aligned to preclude a fluid flow between the set of low-pressure ports and the at least one pressure exchanger tube, and permit a fluid flow between the set of high-pressure ports and the at least one pressure exchanger tube.

4. The valve system of claim 2, wherein in the second axial position the hollow spool is axially aligned to preclude a fluid flow between the set of high-pressure ports and the at least one pressure exchanger tube, and permit a fluid flow between the set of low-pressure ports and the at least one pressure exchanger tube.

5. The valve system of claim 2, wherein in a third axial position the hollow spool is axially aligned to preclude a fluid flow between the set of high-pressure ports and the at least one pressure exchanger tube, and between the at least one pressure exchanger tube and the set of low-pressure ports and wherein the third axial position is between the first axial position and the second axial position.

6. The valve system of claim 1, wherein the hollow tubular flow distributor comprises one or more sets of circumferential openings axially aligned with the set of high-pressure ports and the set of low-pressure ports.

7. The valve system of claim 2, wherein in the first axial position the hollow spool is axially aligned to preclude a fluid flow between the set of high-pressure ports and a first set of circumferential openings.

8. The valve system of claim 2, wherein in the second axial position the hollow spool is axially aligned to preclude a fluid flow between a second set of circumferential openings and the set of low-pressure ports.

9. The valve system of claim 5, wherein in the third axial position the hollow spool is axially aligned to preclude a fluid flow between the set of high-pressure ports and a first set of circumferential openings, and between a second set of circumferential openings and the set of low-pressure ports and wherein the third axial position is between the first axial position and the second axial position.

10. The valve system of claim 2, wherein a radial clearance between the hollow spool and the tubular valve housing is minimized in order to substantially reduce fluid flow between the set of high-pressure ports and the set of low-pressure ports, when the hollow spool is transitioning from the first axial position to the second axial position or vice versa.

11. The valve system of claim 2, wherein the hollow spool comprises radial openings proximate the axial ends to substantially hydraulically balance the hollow spool when the hollow spool is in the first axial position or the second axial position.

12. The valve system of claim 1, wherein the sealing system comprises axial seals at both ends of the tubular valve housing.

13. The valve system of claim 1, wherein the sealing system comprises radial seals that substantially precludes a fluid flow between the set of high-pressure ports and the set of low-pressure ports.

14. The valve system of claim 1, further comprising a valve actuator and wherein the valve actuator comprises:
a tubular actuator housing connected to the tubular valve housing;
an actuator piston reciprocating inside the tubular actuator housing; and
an actuator shaft for connecting the actuator piston to the hollow spool.

15. The valve system of claim 14, wherein the actuator piston is actuated by electromagnetic means.

16. The valve system of claim 14, wherein the actuator piston is actuated by pneumatic means.

17. The valve system of claim 14, wherein the actuator piston is actuated by hydraulic means.

18. The valve system of claim 14, wherein the hollow spool further comprises a connecting member to receive the actuator shaft.

19. The valve system of claim 18, wherein the hollow tubular flow distributor comprises at least one opening to permit the connecting member of the hollow spool to reciprocate between a first axial position and a second axial position.

20. A valve system for an energy recovery system having at least one pressure exchanger tube, the valve system comprising:
a tubular valve housing connected to the pressure exchanger tube;
a hollow tubular flow distributor located inside the tubular valve housing;
a hollow spool configured to reciprocate axially in a radial clearance between the tubular valve housing and the hollow tubular flow distributor; and
a valve actuator comprising:
a tubular actuator housing connected to the tubular valve housing;
an actuator piston reciprocating inside the tubular actuator housing; and
an actuator shaft for connecting the actuator piston to the hollow spool.

21. The valve system for an energy recovery system according to any of the preceding claims, wherein the valve system is configured for a desalination system.
